(19) United States
(12) Patent Application Publication
(10) Pub. No.: US 2026/0216847 A1
(43) Pub. Date: Jul. 30, 2026

(54) Multi-Drive Wrench Socket Device

(71) Applicant: Ryan Gibson, Blue Springs, MO (US)

(72) Inventor: Ryan Gibson, Blue Springs, MO (US)

(21) Appl. No.: 19/364,253

(22) Filed: Oct. 21, 2025

Related U.S. Application Data
(60) Provisional application No. 63/751,344, filed on Jan. 30, 2025.

(51) Int. Cl. B25B 13/48

(52) U.S. Cl. CPC B25B 13/481

(57) ABSTRACT

A multi-drive wrench socket device is provided. The device is comprised of a central body having first and second receiving areas designed with 12-point and 8-point socket geometries. The first side features a 12-point female socket with radially-arranged engagement surfaces suited for standard fasteners, while the second side includes an 8-point male socket compatible with square, double-square, and partial 12-point fastener engagement. The central body houses a drive opening adaptable to multiple standard square drive sizes, enabling torque input through diverse tools such as ratchets and wrenches. A method of use is also provided, outlining steps for engaging a fastener with the appropriate receiving area, applying torque via the drive opening, and disengaging the fastener after use.

### CROSS-REFERENCE TO RELATED APPLICATION

The present application claims priority to, and the benefit of, U.S. Provisional Application No. 63/751,344, which was filed on January 30, 2025, and is incorporated herein by reference in its entirety.

### FIELD OF THE INVENTION

The present invention relates generally to the field of sockets. More specifically, the present invention relates to a dual-ended torque transfer device comprising a central body with 12-point and 8-point socket geometries on opposing ends. Accordingly, the present disclosure makes specific reference thereto. Nonetheless, it is to be appreciated that aspects of the present invention are also equally applicable to other like applications, devices, and methods of manufacture.

### BACKGROUND

In various mechanical and technical fields, such as automotive repair, aviation maintenance, and equipment assembly, technicians frequently encounter fasteners located in confined or obstructed spaces. These areas often present significant challenges when using conventional socket wrenches or standard hand tools due to their size and geometry. Socket wrenches, while effective in open and accessible environments, tend to be bulky and unsuitable for maneuvering within narrow or recessed regions. This limitation often leads to incomplete fastening or removal operations, delays in workflow, or the need for specialized tools that are not always readily available. Additionally, hardware in such environments may require varied socket profiles, including both metric and standard sizes, further complicating tool selection. The limited compatibility of traditional sockets with various drive mechanisms restricts the ability of technicians to utilize alternate tools, especially when operating under constrained physical conditions. Current tools may also lack the structural flexibility required to interface effectively with multiple types of fasteners and drive systems, resulting in inefficiencies and increased labor time.

Therefore, there exists a long-felt need in the art for a multi-drive wrench socket device that facilitates access to fasteners located in tight or obstructed spaces. There also exists a long-felt need in the art for a multi-drive wrench socket device that supports compatibility with a broad range of fastener profiles, including metric, standard, and universal spline configurations. Moreover, there exists a long-felt need in the art for a multi-drive wrench socket device that enables multiple drive tool utilization through a dual-sided design and external engagement geometry.

The subject matter disclosed and claimed herein, in one embodiment thereof, comprises a multi-drive wrench socket device. The device is comprised of a central body having first and second receiving areas designed with 12-point and 8-point socket geometries. The first side features a 12-point female socket with radially-arranged engagement surfaces suited for standard fasteners, while the second side includes an 8-point male socket compatible with square, double-square, and partial 12-point fastener engagement. The central body houses a drive opening adaptable to multiple standard square drive sizes, enabling torque input through diverse tools such as ratchets and wrenches. A method of use is also provided, outlining steps for engaging a fastener with the appropriate receiving area, applying torque via the drive opening, and disengaging the fastener after use.

In this manner, the multi-drive wrench socket device of the present invention accomplishes all the foregoing objectives and provides combined functionality of a 12-point and 8-point socket on opposite axial ends, thereby allowing secure engagement with a variety of fasteners across different industries. The 12-point side provides compatibility with a wide range of standard and metric fasteners, while the 8-point side accommodates various drive tools, including open-end wrenches, ratcheting wrenches, and socket wrenches. The dual-profile design enables torque transfer in confined spaces where traditional sockets fail, enhancing operational flexibility. Furthermore, the device’s standardized square drive recesses support direct interfacing with commonly used ratchets and torque tools, while its material composition ensures structural integrity under high stress. Through these features, the multi-drive wrench socket device provides a reliable and adaptable solution for improving workflow efficiency in mechanical, automotive, and aerospace applications.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-drive wrench socket device. The device is configured to engage, manipulate, and transfer torque to fasteners located in confined or obstructed environments where conventional tools are ineffective. A dual-ended structure comprising distinct socket geometries enables compatibility with various tool profiles and fastener types.

More specifically, the device is comprised of a first side and a second side located on opposite axial ends of a central body. The central body may be cylindrical, hexagonal, or of another suitable shape. The first side is comprised of a receiving area that may be formed as either a 12-point female socket or a 12-point male profile. The 12-point geometry includes radially arranged engagement surfaces forming twelve engagement peaks or corners. Each engagement surface may be separated by an internal or external angle.

The second side is comprised of a receiving area configured in an 8-point geometry, which may be formed as either a male or female profile. The 8-point geometry includes radially spaced engagement surfaces defining points oriented at varying angular intervals. This configuration allows multiple partial engagement positions and enhances compatibility with non-standard fasteners. The receiving area may also enable partial engagement with 12-point fasteners.

The central body may include at least one drive opening adapted for use with square drive stems. The drive opening may accept standard square drive sizes and may be located concentrically or offset within one or both receiving areas to alter torque transfer characteristics. A visible indicia may indicate the device size. The device may be compatible with various tool engagement interfaces, including square drive ratchets, open-end wrenches, adjustable crescent wrenches, box-end ratcheting wrenches, crowfoot wrenches, and combination spanners. The dual-geometry design supports broad compatibility.

The invention also includes a method of using the device. A device with a central body having a first and second side with 12-point and 8-point geometries, respectively, is provided. A compatible fastener or tool is selected based on the geometry. The fastener or tool is engaged using the radial arrangement of engagement surfaces. A square drive tool is inserted into the drive opening, and torque is applied to manipulate the fastener. The device is then disengaged by reversing torque and removing the fastener or tool.

Accordingly, the multi-drive wrench socket device of the present invention is particularly advantageous as it provides combined functionality of a 12-point and 8-point socket on opposite axial ends, thereby allowing secure engagement with a variety of fasteners across different industries. The 12-point side provides compatibility with a wide range of standard and metric fasteners, while the 8-point side accommodates various drive tools, including open-end wrenches, ratcheting wrenches, and socket wrenches. The dual-profile design enables torque transfer in confined spaces where traditional sockets fail, enhancing operational flexibility. Furthermore, the device’s standardized square drive recesses support direct interfacing with commonly used ratchets and torque tools, while its material composition ensures structural integrity under high stress. Through these features, the multi-drive wrench socket device provides a reliable and adaptable solution for improving workflow efficiency in mechanical, automotive, and aerospace applications. In this manner, the multi-drive wrench socket device overcomes the limitations of existing sockets and fastening tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multi-drive wrench socket device of the present invention in accordance with the disclosed architecture;

FIG. 2 illustrates a top view of a first end of one potential embodiment of a multi-drive wrench socket device of the present invention in accordance with the disclosed architecture;

FIG. 3 illustrates a top view of a second end of one potential embodiment of a multi-drive wrench socket device of the present invention in accordance with the disclosed architecture; and

FIG. 4 illustrates a flowchart of a method of using one potential embodiment of a multi-drive wrench socket device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multi-drive wrench socket device that facilitates access to fasteners located in tight or obstructed spaces. There also exists a long-felt need in the art for a multi-drive wrench socket device that supports compatibility with a broad range of fastener profiles, including metric, standard, and universal spline configurations. Moreover, there exists a long-felt need in the art for a multi-drive wrench socket device that enables multiple drive tool utilization through a dual-sided design and external engagement geometry.

The present invention, in one exemplary embodiment, is comprised of a multi-drive wrench socket device. The device is designed to engage, manipulate, and transfer torque to fasteners situated in confined or obstructed environments where conventional tools are not effective. A dual-ended configuration comprising distinct socket geometries allows compatibility with a range of tool profiles and fastener types.

More specifically, the device is comprised of a first side and a second side positioned on opposite axial ends of a central body. The central body may be cylindrical, hexagonal, or formed in another suitable shape. The first side includes a receiving area that may be configured as either a 12-point female socket or a 12-point male profile. The 12-point geometry incorporates radially arranged engagement surfaces that form twelve engagement peaks or corners. Each engagement surface may be separated by an internal or external angle.

The second side includes a receiving area formed in an 8-point geometry, which may be configured as either a male or female profile. The 8-point geometry features radially spaced engagement surfaces defining points arranged at various angular intervals. This design permits multiple partial engagement positions and increases compatibility with non-standard fasteners. The receiving area may also facilitate partial engagement with 12-point fasteners.

The central body may incorporate at least one drive opening adapted to interface with square drive stems. The drive opening may accommodate standard square drive sizes and may be positioned concentrically or offset within one or both receiving areas to adjust torque transfer characteristics. A visible indicia may be included to indicate the device size. The device is compatible with various tool engagement interfaces, including square drive ratchets, open-end wrenches, adjustable crescent wrenches, box-end ratcheting wrenches, crowfoot wrenches, and combination spanners. The dual-geometry design enhances versatility.

The invention also includes a method of using the device. A device featuring a central body with first and second sides comprising 12-point and 8-point geometries, respectively, is provided. A compatible fastener or tool is selected according to the geometry. The fastener or tool is engaged using the radial arrangement of engagement surfaces. A square drive tool is inserted into the drive opening, and torque is applied to actuate the fastener. The device is then disengaged by reversing the torque and removing the fastener or tool.

Therefore, the multi-drive wrench socket device provides combined functionality of 12-point and 8-point sockets on opposite axial ends, enabling secure engagement with a variety of fasteners across multiple industries. The 12-point side supports a wide range of standard and metric fasteners, while the 8-point side is compatible with various drive tools, including open-end wrenches, ratcheting wrenches, and socket wrenches. The dual-profile configuration enables torque transfer in restricted spaces where traditional sockets are ineffective, increasing operational adaptability. Additionally, standardized square drive recesses allow direct connection with commonly used ratchets and torque tools, and the material composition ensures durability under high stress. These features collectively establish the multi-drive wrench socket device as a reliable and flexible solution for enhancing efficiency in mechanical, automotive, and aerospace applications, thereby addressing the limitations of existing socket and fastening tools.

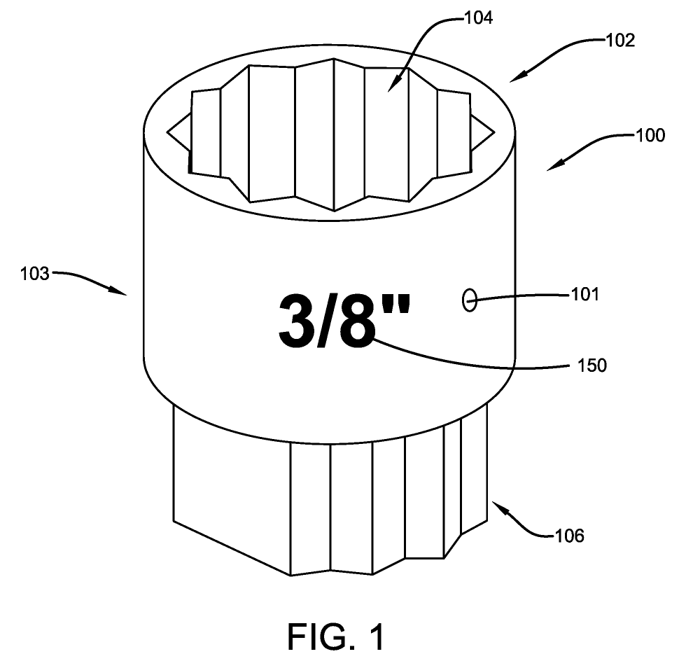

Referring initially to the drawings, FIG. 1 illustrates a perspective view of one potential embodiment of a multi-drive wrench socket device 100 of the present invention in accordance with the disclosed architecture. The device 100 is configured to enable the engagement, manipulation, and transfer of torque to fasteners situated in confined, obstructed, or limited-access environments where conventional hand tools or sockets may not provide effective access or engagement. The device 100 achieves this utility through a dual-ended structure comprising different socket geometries, facilitating compatibility with a wide range of tool profiles and fastener types.

In one embodiment, the device 100 is comprised of a first side 102 and a second side 106 located on opposite axial ends of a central body 103. The central body 103 may be cylindrical, hexagonal, or another suitable shape in different embodiments.

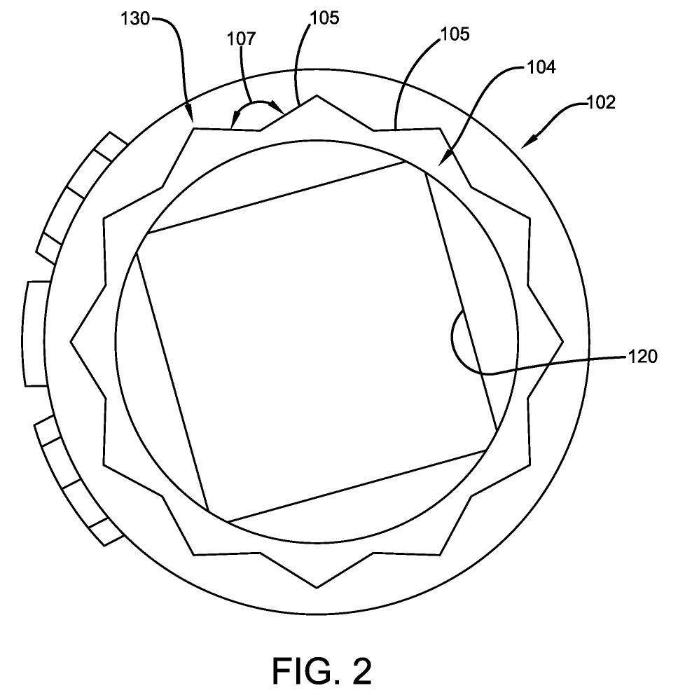

The first side 102 is comprised of a receiving area 104, as seen in FIG. 2. In one embodiment, the receiving area 104 may be formed as a 12-point female socket configured to engage standard 12-point male fasteners. In another embodiment, the receiving area 104 may be formed as a 12-point male profile for engagement with female sockets or recesses. The 12-point geometry of the receiving area 104 may be comprised of at least one (but preferably twenty-four) radially-arranged engagement surfaces 105 (preferably arranged to form twelve engagement peaks/corners 130). Each engagement surface 105 may be separated by an internal or external angle 107, typically, but not limited to, an angular range between 1 and 90 degrees.

The receiving area 104 may be further configured as a shallow cavity, a mid-depth recess, or a deep-well geometry, allowing for axial accommodation of fasteners positioned at varying depths. The depth selection may be governed by the intended use environment, such as recessed cavities, protruding studs, or in-line fastener arrangements.

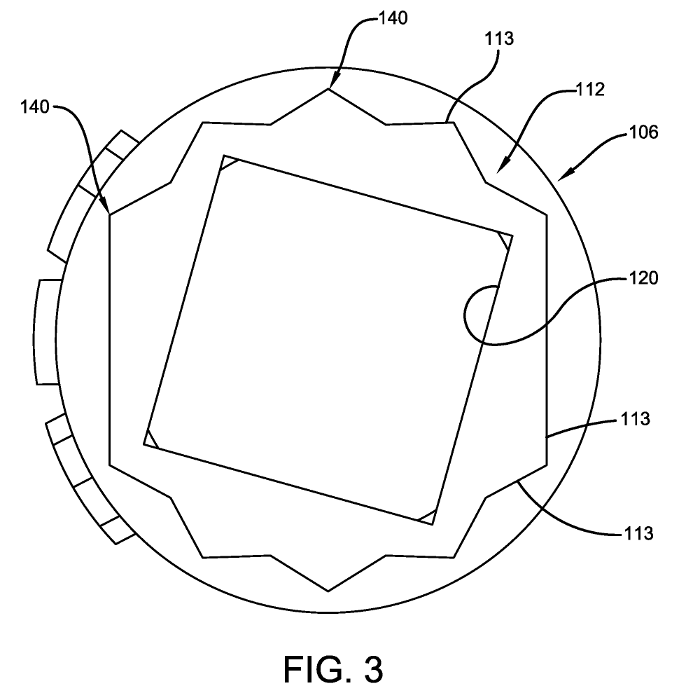

The second side 106 is comprised of a receiving area 112 configured in an 8-point geometry, as seen in FIG. 3. In one embodiment, the receiving area 112 may be an 8-point male profile intended to be inserted into a female 8-point tool, such as a socket or box-end wrench. In an alternate embodiment, the receiving area 112 may be formed as a female 8-point profile for mating with square or double-square male fasteners or drive tools. The 8-point geometry of the receiving area 112 may be comprised of at least one (but preferably twenty) radially spaced engagement surfaces that may define points 140 oriented at angular intervals such as, but not limited to, between 1 and 179 degrees. This angular variability allows for multiple partial engagement positions, thereby enhancing adaptability across varying tool and fastener designs. The receiving area 112 may further enable partial engagement with 12-point fasteners, providing an extended range of applications in scenarios where full contact engagement is impractical. This feature enhances the utility of the device 100 in emergency repairs or non-standard tool access scenarios.

The central body 103 of the device 100 may be configured to include at least one drive opening 120 adapted to interface with standard square drive stems. In various embodiments, the drive opening 120 may be formed to accept square drive sizes including, but not limited to, 1/4", 3/8", 1/2", and 3/4", enabling torque application through ratchets, torque wrenches, and breaker bars. In one embodiment, this size of the device 100 may be displayed via at least one indicia 150 on the body 103, as seen in FIG. 1. The drive opening 120 may be positioned concentrically within one or both receiving areas 104 and 112, or may be offset relative to the central axis of the device 100 to modify the torque transfer characteristics.

The device 100 may be configured for use with a variety of tool engagement interfaces, including, but not limited to, square drive ratchets, open-end wrenches, adjustable crescent wrenches, box-end ratcheting wrenches, crowfoot wrenches, and combination spanners. The dual-geometry design enhances compatibility across both professional and consumer toolsets.

In one or more embodiments, the device 100 may be manufactured from high-strength materials capable of withstanding elevated torsional loads, impact forces, and surface abrasion. Suitable materials may include, but are not limited to, hardened carbon steel, chrome vanadium steel, chrome molybdenum steel, and stainless steel alloys. Additional materials may comprise high-strength non-ferrous alloys or composite materials for applications requiring non-sparking or corrosion-resistant properties.

The device 100 may be subjected to heat treatment processes to increase core strength and surface hardness. Optional surface finishes 101 may be applied to enhance corrosion resistance and tool visibility. These finishes may include electroplating (e.g., nickel or chrome), black oxide coatings, etc.

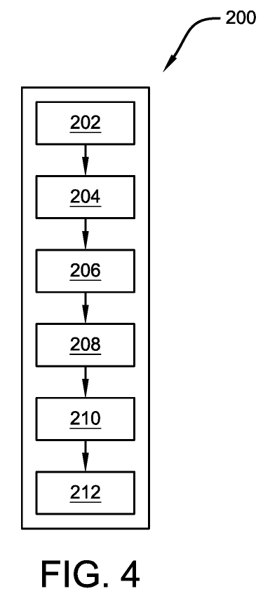

The present invention is also comprised of a method of using 200 the device 100, as seen in FIG. 4. First, a device 100 is provided comprised of a central body 103 having a first side 102 with a receiving area 104 and a second side 106 with a receiving area 112, wherein the receiving area 104 comprises a 12-point geometry and the receiving area 112 comprises an 8-point geometry [Step 202]. Then, a user can select a compatible fastener or tool engagement interface based on the profile and geometry of the receiving area 104 or 112, including, but not limited to, male or female 12-point or 8-point fasteners or tools [Step 204]. Next, the user can engage the selected fastener or tool into the corresponding receiving area 104 or 112, wherein the engagement is facilitated by the radial arrangement of engagement surfaces 105 or 140, enabling secure partial or full contact with the fastener or tool [Step 206]. Then, a square drive tool such as a ratchet, torque wrench, or breaker bar can be inserted into the drive opening 120 located within or adjacent to the receiving areas 104 or 112, wherein the drive opening 120 is selected to match the drive size of the tool [Step 208]. Next, torque can be applied through the square drive tool, transferring rotational force through the device 100 to the engaged fastener or tool interface, thereby enabling tightening or loosening of the fastener within a confined, obstructed, or limited-access environment [Step 210]. Finally, the device 100 can be disengaged from the fastener or tool by reversing the applied torque and removing the fastener or tool from the receiving area 104 or 112 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-drive wrench socket device” and “device” are interchangeable and refer to the multi-drive wrench socket device 100 of the present invention.

Notwithstanding the foregoing, the multi-drive wrench socket device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multi-drive wrench socket device 100 as shown in the FIGS. are for illustrative purposes only, and that many other sizes and shapes of the multi-drive wrench socket device 100 are well within the scope of the present disclosure. Although the dimensions of the multi-drive wrench socket device 100 are important design parameters for user convenience, the multi-drive wrench socket device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-drive wrench socket device comprising:
a central body having a first side and a second side located on opposite axial ends of the central body;
a first receiving area positioned on the first side of the central body, the receiving area comprising a 12-point geometry formed by a first plurality of radially-arranged engagement surfaces; and
a second receiving area positioned on the second side of the central body, the receiving area comprising an 8-point geometry formed by a second plurality of radially-arranged engagement surfaces.

2. The multi-drive wrench socket device of claim 1, wherein the first receiving area is comprised of a female receiving area.

3. The multi-drive wrench socket device of claim 1, wherein the second receiving area is comprised of a male receiving area.

4. The multi-drive wrench socket device of claim 1, wherein the central body is comprised of a drive opening.

5. The multi-drive wrench socket device of claim 4, wherein the drive opening is comprised of a 1/4", 3/8", 1/2", or 3/4" drive opening.

6. The multi-drive wrench socket device of claim 4, wherein the drive opening is positioned concentrically within the first receiving area and the second receiving area.

7. The multi-drive wrench socket device of claim 1, wherein the central body is comprised of an electroplating.

8. The multi-drive wrench socket device of claim 1, wherein the central body is comprised of a black oxide coating.

9. The multi-drive wrench socket device of claim 1, wherein the first receiving area is comprised of a deep-well geometry.

10. The multi-drive wrench socket device of claim 1, wherein the second receiving area is comprised of a deep-well geometry.

11. A multi-drive wrench socket device comprising:
a central body comprised of an indicia and having a first side and a second side located on opposite axial ends of the central body;
a first receiving area positioned on the first side of the central body, the receiving area comprising a 12-point geometry formed by a first plurality of radially-arranged engagement surfaces; and
a second receiving area positioned on the second side of the central body, the receiving area comprising an 8-point geometry formed by a second plurality of radially-arranged engagement surfaces.

12. The multi-drive wrench socket device of claim 11, wherein the first receiving area is comprised of a male receiving area.

13. The multi-drive wrench socket device of claim 11, wherein the second receiving area is comprised of a female receiving area.

14. The multi-drive wrench socket device of claim 11, wherein the central body is comprised of a drive opening.

15. The multi-drive wrench socket device of claim 14, wherein the drive opening is comprised of a 1/4", 3/8", 1/2", or 3/4" drive opening.

16. The multi-drive wrench socket device of claim 14, wherein the drive opening is positioned concentrically within the first receiving area and the second receiving area.

17. The multi-drive wrench socket device of claim 11, wherein the central body is comprised of an electroplating.

18. The multi-drive wrench socket device of claim 11, wherein the central body is comprised of a black oxide coating.

19. The multi-drive wrench socket device of claim 11, wherein the multi-drive wrench socket device is comprised of a heat-treated body.

20. A method of using a multi-drive wrench socket device, the method comprising the following steps:
providing a multi-drive wrench socket device comprised of a central body having a first side with a first receiving area and a second side with a second receiving area, wherein the first receiving area comprises a 12-point geometry and the second receiving area comprises an 8-point geometry;
selecting a compatible fastener or tool engagement interface based on the profile and geometry of one of the first receiving area or the second receiving area;
engaging the compatible fastener or the tool engagement interface into the first receiving area or the second receiving area;
inserting a square drive tool into a drive opening located within the central body; and
applying torque through the square drive tool to transfer a rotational force through the multi-drive wrench socket device to the compatible fastener or the tool engagement interface.
